(19) United States
(12) Patent Application Publication
(10) Pub. No.: US 2015/0015517 A1
(43) Pub. Date: Jan. 15, 2015

(54) TOUCH PANEL AND DISPLAY DEVICE

(71) Applicant: BOE TECHNOLOGY GROUP CO., LTD., Beijing (CN)

(72) Inventor: Lijun Zhao, Beijing (CN)

(21) Appl. No.: 14/351,716

(22) PCT Filed: Nov. 19, 2013
(86) PCT No.: PCT/CN2013/087383

§ 371 Date: Apr. 14, 2014

(30) Foreign Application Priority Data
May 30, 2013 (CN) 201310209353.8

(51) Int. Cl. G06F 3/041

(52) U.S. Cl. CPC G06F 3/041
USPC 345/173

(57) ABSTRACT

A touch panel and a display device are provided. The touch panel includes a first substrate, a color filter layer including a plurality of color pixel units arranged in a matrix being disposed on the first substrate, the first substrate further including a plurality of touch sensing electrodes and a plurality of touch driving electrodes, wherein, the touch sensing electrodes are disposed between color pixel units in adjacent rows or in adjacent column and have a function of shielding light; and the touch driving electrodes are disposed to be insulated from and cross the touch sensing electrodes, and are applied with touch scanning signals at a touch stage and are applied with common electrode signals at a display stage. The above touch panel can simplify the structure and the manufacturing process of in-cell touch panels.

### TECHNICAL FIELD

Embodiments of the invention relate to a touch panel and a display device.

### BACKGROUND

Touch panels are becoming more attractive as new man-machine interactive devices. The conventional touch panels mostly are capacitive touch panels. The capacitive touch panels may be classified into in-cell touch panels and add-on touch panels.

An add-on touch panel is formed by manufacturing a touch panel and a liquid crystal display panel separately and combining them together to become a liquid crystal display panel have touch function, so the add-on touch panel has defects such as high manufacturing cost, low light transmittance, thick module, and so on. An in-cell touch panel is formed by embedding the touch electrodes of a touch panel into the internal portion of a liquid crystal display panel, so it is possible to reduce the thickness of module and reduce the manufacturing costs of the touch panel.

Currently, an in-cell touch panel is formed generally by separately adding touch electrodes on a conventional array substrate and/or a conventional color filter substrate. During manufacturing of the in-cell touch panel, it is necessary to make touch electrodes on the array substrate and/or the color filter substrate. Specifically, after completion of the related manufacturing processes of the array substrate and/or the color filter substrate, the process for making touch driving electrodes and touch sensing electrodes disposed to be insulated from and cross each other are additionally performed. For example, the process for forming the touch electrodes inside of a color filter substrate to realize the in-cell touch panel is performed after the processes for making BM (black matrix), R/G/B color filter layer, PS (pillar spacer) and the like have been finished, and the manufacturing flow is long due to the addition of the process for forming the touch driving electrodes and the touch sensing electrodes.

In the above structure design of the in-cell touch panel, BM (black matrix) and the touch sensing electrodes employ a double-layer structure, so the structure of the touch panel is relatively sophisticated and at the same time the manufacturing process is also relatively complicated, which result in high cost.

### SUMMARY

A embodiment of the invention provides a touch panel comprising: a first substrate, which is provided thereon with a color filter layer comprising a plurality of color pixel units arranged in a matrix being, the first substrate further comprising a plurality of touch sensing electrodes and a plurality of touch driving electrodes. The touch sensing electrodes are disposed between color pixel units in adjacent rows or in adjacent column and have a function of shielding light; and the touch driving electrodes are disposed to be insulated from and cross the touch sensing electrodes, and are applied with touch scanning signals at a touch stage and are applied with common electrode signals at a display stage.

Another embodiment of the invention provides a display device comprising the above touch panel.

### BRIEF DESCRIPTION OF THE DRAWINGS

For better understanding technical proposals according to embodiments of the present invention, drawings of the embodiments will be described briefly below. Obviously, drawings in the following description only relate to some embodiments of the present invention, not to limit the present invention.

FIG. 1 is a schematic cross-sectional view of a touch panel provided in an embodiment of the invention;

FIG. 2 is a schematic cross-sectional view of another touch panel provided in an embodiment of the invention;

FIG. 3 is a schematic structural view of a touch driving electrode and a touch sensing electrode in the touch panel provided in an embodiment of the invention;

FIG. 4 is a schematic structural view of another touch driving electrode and another touch sensing electrode in the touch panel provided in an embodiment of the invention;

FIG. 5 is a schematic arrangement view of a light-shielding strip and a touch sensing electrode in the touch panel provided in an embodiment of the invention;

FIG. 6 is a schematic view of a touch sensing electrode group provided in an embodiment of the invention.

FIG. 7 is a schematic view of a touch sensing electrode group disposed with a float electrode provided in an embodiment of the invention;

FIG. 8 is a schematic plan view of a pixel display unit disposed with a metal reflection layer provided in an embodiment of the invention;

FIG. 9 is a schematic plan view of a gap region which is between adjacent pixel display units in a row direction and is covered by the metal reflection layer in the touch panel provided in an embodiment of the invention; and

FIG. 10 is a schematic arrangement view of a touch sensing electrode in a transflective display device provided in an embodiment of the invention.

### DETAILED DESCRIPTION

In order to make the purpose, technology solution and advantages of embodiments of the present invention more clear, technology solutions according to embodiments of the present invention will be described clearly and completely below with respect to drawings of embodiments of the present invention. It is to be understood that the described embodiments are part of but not all of embodiments of the present invention. Based on the described embodiments of the present invention, all other embodiments obtained by those of ordinary skill in the art without any creative labor fall into the protecting scope of the present invention.

An embodiment of the invention provides a touch panel and a display device to solve problems such as the sophisticated structure of the touch panel, the complicated manufacturing process and the like present in the state of art.

### Embodiment 1

The embodiment of the invention provides a touch panel comprising a first substrate and a color filter layer, a plurality of touch sensing electrodes and a plurality of touch driving electrodes that are disposed on the first substrate; a plurality of color pixel unit are disposed in the color filter layer; the touch sensing electrodes are disposed between adjacent color pixel units and have a function of shielding light; and the touch driving electrodes are disposed to be insulated from and cross the touch sensing electrodes, and are applied with touch scanning signals at a touch stage and are applied with common electrode signals at a display stage.

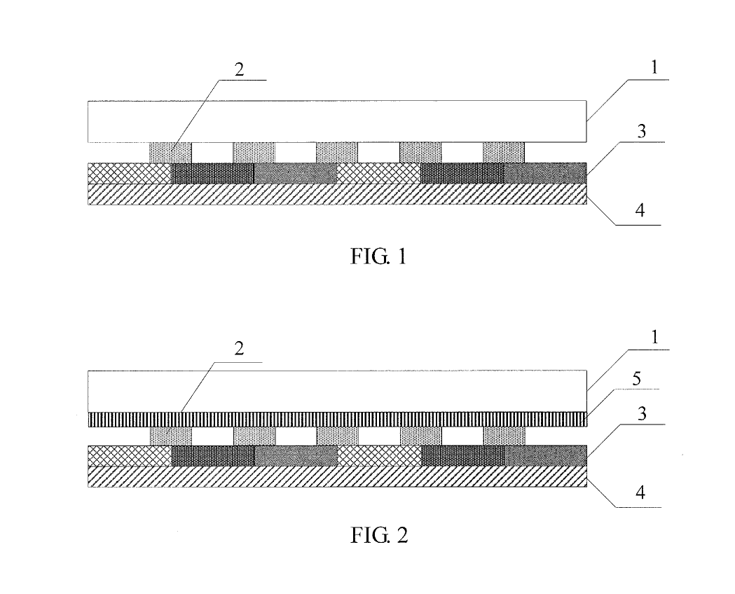

In the embodiment 1 of the invention, the touch panel provided in the embodiment of the invention are described in details in the case where a color filter substrate having a color filter layer is employed as an example of the first substrate, and the color filter substrate comprises a substrate 1, touch sensing electrodes 2, a color filter layer 3 and touch driving electrodes 4, as illustrated in FIG. 1. In FIG. 1, the color filter layer 3 comprises a plurality of color pixel units arranged in a matrix form, the touch sensing electrodes 2 are disposed on the side of the color filter layer 3 facing the substrate 1, and are disposed between the color pixel units in adjacent rows or in adjacent columns in the color filter layer 3. In this embodiment, the case where the touch sensing electrodes are disposed between the color pixel units in adjacent columns is shown. The touch driving electrodes 4 are disposed on the side of the color filter layer 3 opposite to the substrate 1 and are disposed to cross the touch sensing electrodes 2. In this embodiment, the touch sensing electrodes 2 and the touch driving electrodes 4 are disposed on different sides of the color filter layer 3, but this configuration is only for illustrating purpose and is not of limitative, and in embodiment of the invention, it is workable as long as the touch driving electrodes are disposed to be insulated from and cross the touch sensing electrodes.

In the embodiment of the invention, the touch driving electrodes 4 are applied with different signals at different stages, specifically, the touch driving electrodes 4 are applied with touch scanning signals to act as touch driving electrodes at a touch stage, and are applied with common electrode signals to act as common electrodes at a display stage, that is, the touch driving electrodes 4 also function as common electrodes at the display stage without common electrodes being provided separately. The touch sensing electrodes 2 are disposed between adjacent color pixel units and have a function of shielding light, that is, the touch sensing electrodes 2 not only have a function as touch sensing electrodes but also function as black matrix strips in a column direction between the color pixel units so as to shield light for preventing light leakage without black matrix strips being provided separately in the column direction. Therefore, the embodiment of the invention simplifies the structure and the manufacturing process of the in-cell touch panel, reduces the costs and facilitates to realize light-weight and slim in-cell touch panels.

Common electrode signal input lines connected to the common electrodes are disposed in the driving and controlling circuits of the color filter substrate. In the embodiment of the invention, the touch driving electrodes 4 are disposed at the locations of the color filter substrate where the common electrodes need to be disposed, so the touch driving electrodes 4 can be connected to the common electrode signal input lines of the color filter substrate in the embodiment of the invention. In this way, the common electrode signal input lines of the color filter substrate can function as touch scanning signal input lines as well, that is, function as the touch scanning signal input lines for the touch driving electrodes 4 of the touch panel at the touch stage to apply the touch scanning signals to the touch driving electrodes 4, and function as the common electrode signal input lines at the display stage to apply the common electrode signals to the touch driving electrodes 4, so that the touch driving electrodes 4 of the color filter substrate have a function of common electrodes as well as having a function of touch driving electrodes. In this way, it is unnecessary to separately design the touch scanning signal input lines for the touch driving electrodes. Certainly, in the embodiment of the invention, it is possible to dispose the common electrode signal input lines and the touch scanning signal input lines separately and apply different signals to the touch driving electrodes 4 respectively.

In the embodiment of the invention, the touch sensing electrodes 2 are disposed between color pixel units in adjacent columns and have a function of shielding light. Therefore, in the embodiment of the invention, an opaque conductive oxide or a metal material can be selected as the material of the touch sensing electrodes so that they can shield light to function as a black matrix and can have an electrical conduction function to act as touch sensing electrodes. Because the conventional black matrix is not connected to signal output lines, in the embodiment of the invention, for the purpose of facilitating the outputting of the touch signals and alleviating the change to the conventional color filter substrate structure, touch signal output lines may be separately provided and electrically connected to the touch sensing electrodes 2 for shielding light, thereby outputting touch sensing signals and determining the touch positions.

In embodiment of the invention, the touch scanning signal input lines for the touch driving electrodes 4 and the touch signal output lines corresponding to the touch sensing electrodes 2 are provided on different layers of the color filter substrate separately; or the touch scanning signal input lines and the touch signal output lines are provided on the same layer so as to improve the product shield of the circuit design.

In the touch panel provided in the embodiment of the invention, the touch sensing electrodes and the touch driving electrodes are disposed on the first substrate provided with the color filter layer, the touch sensing electrodes are disposed between the color pixel units in adjacent rows or adjacent columns and have a function of shielding light, that is, can function as touch sensing electrodes and function to shield light in stead of the black matrix strips in the row direction or in the column direction; the touch driving electrodes function as touch driving electrode at the touch stage and function as common electrodes at the display stage, so that it is possible to simplify the structure and the manufacturing process of the in-cell touch panel by the touch panel provided in the embodiment of the invention.

### Embodiment 2

The touch panel in embodiment 1 will be described in details in connection with the practical application in the embodiment 2, but the embodiment of the invention is not limited thereto.

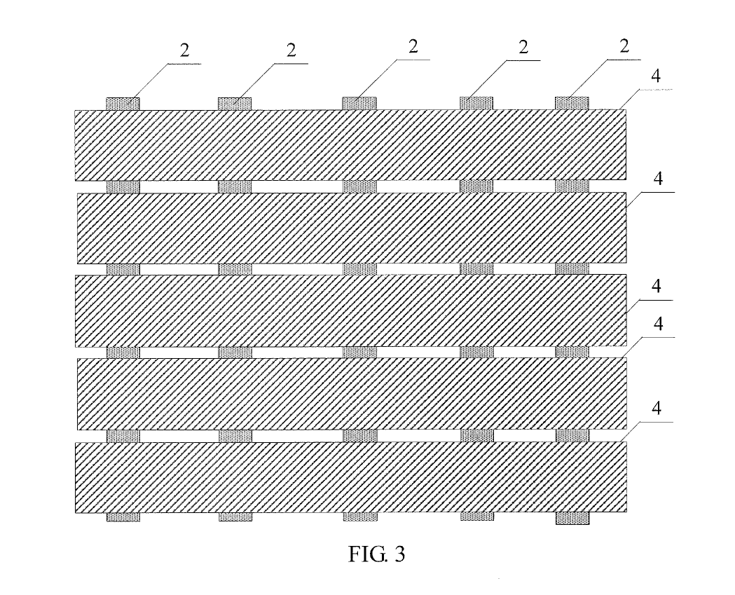

As illustrated in FIG. 2, in the embodiment of the invention, for purpose of realizing touch function, the touch sensing electrodes 2 are disposed to be insulated from and cross the touch driving electrodes 4. In addition, for purpose of preventing light leakage, the touch panel provided in embodiment 2 of the invention is provided with light shielding strips 5 on the first substrate. If the touch sensing electrodes 2 are disposed between color pixel units in adjacent columns, then the light shielding strips 5 are disposed to cross the touch sensing electrodes 2 and also between color pixel units in adjacent rows; and if the touch sensing electrodes 2 are disposed between color pixel units in adjacent rows, then the light shielding strips 5 are disposed to cross the touch sensing electrodes 2 and also between color pixel units in adjacent columns in order to more efficiently shield light.

For example, the light shielding strips 5 provided in the embodiment of the invention may be made of a black resin insulation material so that the light shielding strips 5 and the touch sensing electrodes 2 may be disposed to cross each other without short circuit being caused.

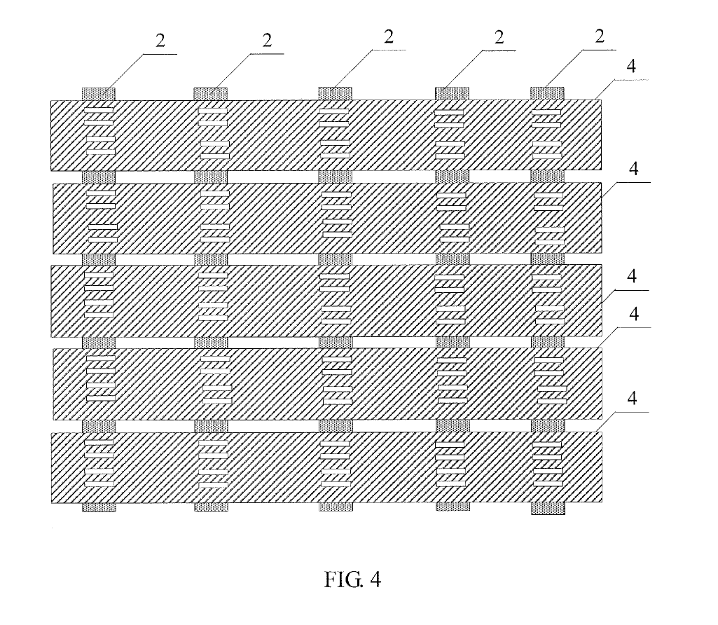

Furthermore, the touch driving electrodes and the touch sensing electrodes provided in the embodiment of the invention may be disposed to have different shapes according to the practical situations, and for example, the touch driving electrodes may have strip-shaped electrode structure as illustrated in FIG. 3. If there is a small distance between the touch driving electrodes and the touch sensing electrodes, for purposes of ensuring the amount of the capacitance upon touching to meet the requirement for touch control, an hollowed-out structure may be disposed at locations where the touch driving electrodes and the touch sensing electrodes overlap each other, for example, the hollowed-out shape may be a slit shape or a hole shape, as illustrated in FIG. 4.

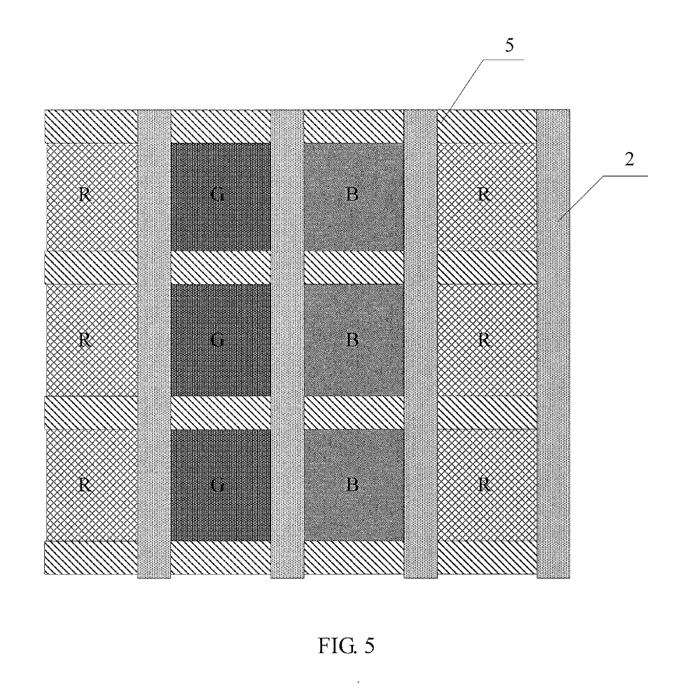

In the embodiment of the invention, for example, the touch driving electrodes and the touch sensing electrodes are disposed to be in a strip-shaped electrode structure, and both of them are respectively disposed in the row direction and the column direction of the color pixel units; for example, the touch driving electrodes are disposed in the row direction of the color pixel units, and the touch sensing electrode are disposed in the column direction of the color pixel units. In the embodiment of the invention, where the touch sensing electrodes are in a stripe-shaped electrode structure, the stripe-shaped touch sensing electrodes are disposed between adjacent color pixel units in the column direction, and the light shielding strips are disposed between adjacent color pixel units in the row direction, as illustrated in FIG. 5. Certainly, in the embodiment of the invention, the touch sensing electrodes, the touch driving electrodes and the light shield strips may be disposed in other ways, and the embodiment of the invention are not limited thereto.

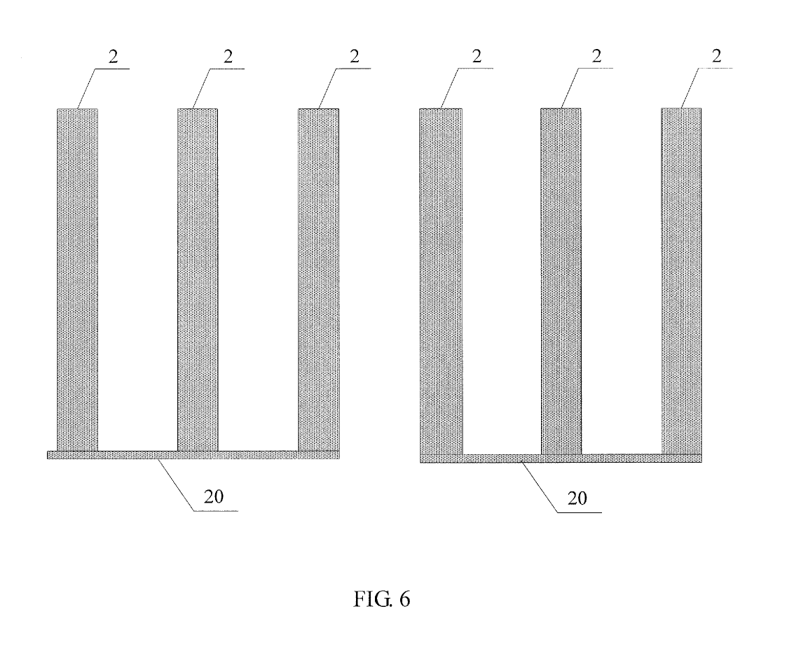

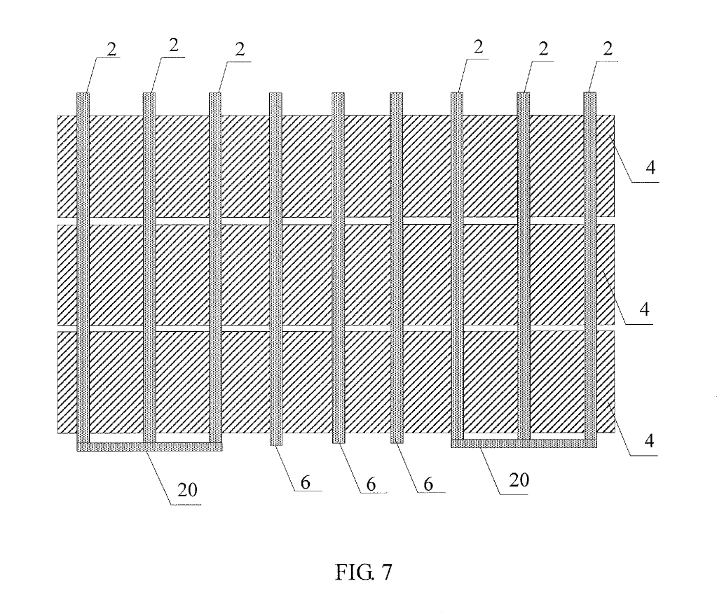

For purpose of realizing the accurate determining of the touch position and increasing the strength of the touch signal, a certain number of strip-shaped touch sensing electrodes disposed in different columns may be connected in parallel and combined into a touch sensing electrode group 20, as illustrated in FIG. 6. In the embodiment of the invention, for purpose of preventing adjacent touch sensing electrode groups from being coupled with each other, float electrodes 6 may be disposed between the adjacent touch sensing electrode groups, as illustrated in FIG. 7. The number of the floating electrodes 6 may be determined as desired, and in the embodiment of the invention, may be 3 to 5. As the floating electrodes 6 are floated or be connected to the ground, it is possible to prevent the electrical coupling between the adjacent touch sensing electrode groups.

In the touch panel provided in embodiment 2 of the invention, the first substrate is provided with the light shielding strips so as to further avoid light leakage, and the shapes and the arrangement manners of the touch driving electrodes and the touch sensing electrodes may be disposed freely, thereby further simplifying the manufacturing process and improving the product yield.

### Embodiment 3

The embodiment of the invention will be described in a case where a transflective display panel is used as an example, but is not limited thereto. The color filter substrate in the transflective display panel provided in the embodiment of the invention has the same structure as those of embodiments 1 and 2, and the description focus on the difference of the embodiment of the invention.

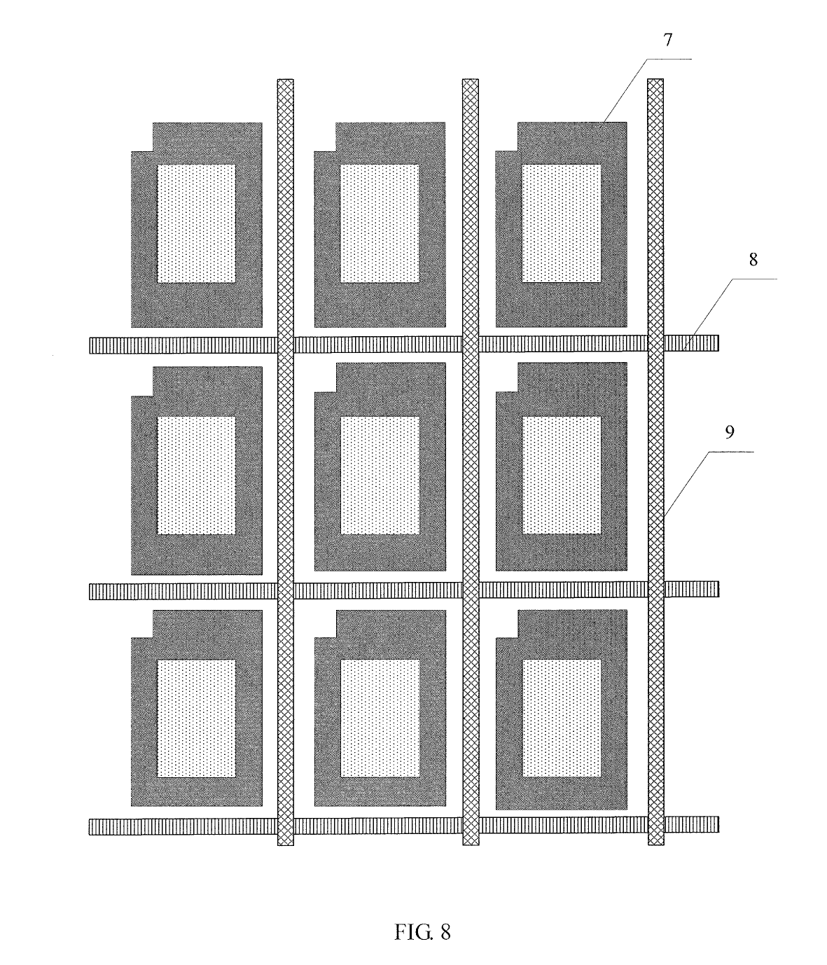

The touch panel provided in the embodiment of the invention also includes a second substrate disposed opposite to the first substrate, and in this embodiment, the second substrate may be an array substrate as illustrated in FIG. 8. The second substrate is formed with a plurality pixel display units arranged in a matrix in the same way as that of the color pixel units arranged on the first substrate in a matrix. In each of the pixel display units, a reflective region and a transmissive region are provided, and the reflective region is disposed around the transmissive region so as to provide a transflective display device. In the transflective display device, a metal reflective layer 7 is disposed in the reflective region of the pixel display unit so as to reflect light. Gate lines 8 and data lines 9 are also provided on the second substrate.

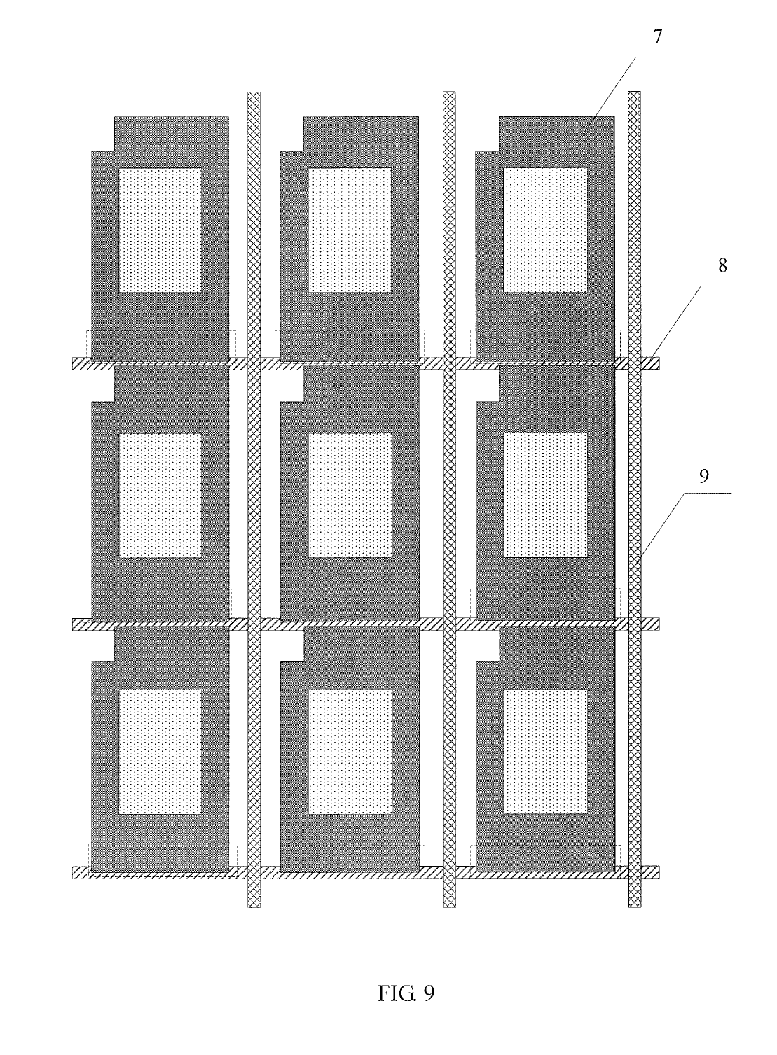

In the embodiment of the invention, for example, the metal reflective layer 7 is extended to partly cover a portion of the region between adjacent pixel display units in the column direction, as illustrated in FIG. 9. The metal reflective layers 7 covering a portion of the region between adjacent pixel display units in the column direction can prevent light from leaking in the covered portion. A gate line 8 is disposed at a gap between the reflective layers 7 in two adjacent pixel display units, so it is possible to shield light leaked from the gap between the reflective layers 7 in the two adjacent pixel display units, and thus it is possible to not dispose a light shielding strip for shielding light between the color pixel units in adjacent rows in the embodiment of the invention.

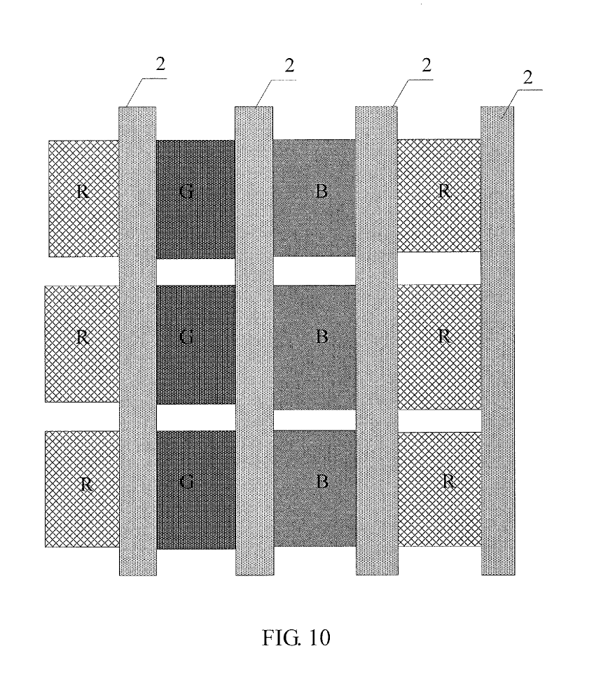

In addition, in the embodiment of the invention, the touch sensing electrodes 2 having a function of shielding light may be disposed between the color pixel units in the adjacent rows so as to function to prevent light leakage as the black matrix, and prevent light emitted from the color filter layer from being mixed, as illustrated in FIG. 10.

In the embodiment of the invention, it is not necessary to dispose light shielding stripes for shielding light on the first substrate provided with the color filter layer, and only the touch sensing electrodes for shielding light are disposed between color pixel units in the adjacent rows so as to function as touch sensing electrodes and act to replace the light shielding strips of the black matrix in the row direction or in the column direction; the touch driving electrodes function as touch driving electrodes at the touch stage and function as common electrodes at the display stage, so that it is possible to simplify the structure and the manufacturing process of the in-cell touch panel by the touch panel provided in the embodiments of the invention.

In the embodiment of the invention, the touch driving electrodes and the touch sensing electrodes may be disposed on different layers, for example, on both sides of the color filter layer so as to insulate them from each other. In addition, in the embodiment of the invention, for purpose of preventing the color mixing in the color filters, the touch sensing electrodes may be disposed in the column direction of the color pixel units. Therefore, for purpose of realizing the touch function, in the embodiment of the invention, the touch driving electrodes may be disposed in the row direction of the color pixel units and on a layer different from that of the touch sensing electrodes.

In the touch panel provided in the embodiment of the invention, the reflective region and the transmissive region disposed on the second substrate can realize the transflective mode, and the metal reflective layer disposed in the reflective region may partly cover a gap region between adjacent pixel display units in the column direction, thereby realizing the light shielding function in the row direction; the formation of the light shielding strips (also referred to as strips of black matrix) can be omitted completely with the arrangement of the reflective metal layer and the touch sensing electrodes. Therefore, the power consumption is reduced while the transflective mode is realized, and therefore the structure and the manufacturing process of the in-cell touch panel are simplified, and it is possible to realize a light-weight, slim touch panel.

### Embodiment 4

Embodiment 4 of the invention also provides a display device comprising the touch panel described in embodiments 1, 2 or 3.

In the display device provided in embodiment 4 of the invention, only the touch sensing electrodes having a function of shielding light and the touch driving electrodes configured for being applied with different signals at different stages are disposed on the first substrate provided with the color filter layer. Furthermore, in the embodiment of the invention, it is possible to omit partially or completely the formation of the light shielding strips, simplify the structure and the manufacturing process of the in-cell touch panel, and also realize both the touch function and the transflective mode so as to reduce the power consumption.

In the touch panel provided in embodiments 1, 2 and 3 and the display device provide in embodiment 4 of the invention, the touch sensing electrodes and the touch driving electrodes are disposed on the first substrate provided with the color filter layer, the touch sensing electrodes are disposed between adjacent color pixel units and have a function of shielding light, the touch driving electrodes are applied with the touch scanning signals at the touch stage, and are applied with the common electrode signals at the display stage. Due to the design of the embodiments of the invention being employed, it is possible to omit partially or completely the formation of the light shielding strips (also referred to as strips of black matrix), and simplify the structure and the manufacturing process of the in-cell touch panel. At the same time, it is possible to realize the transflective mode by using the structure including the metal reflective layer so as to reduce the power consumption.

The above embodiments are only for the purpose of describing technical proposal of the present invention rather than limiting it. While the present invention has been described in detail with reference to the above-mentioned embodiments, those of ordinary skill in the art should understand that they can modify the technical solution recorded in the above embodiments or conduct equivalent substitution for a part of technical features thereof and these modifications or substitutions will not make the nature of respective technical solution to depart from the spirit and scope of technical solutions of embodiments of the present invention.

1. A touch panel comprising a first substrate, which is provided thereon with a color filter layer including a plurality of color pixel units arranged in a matrix, the first substrate further comprising a plurality of touch sensing electrodes and a plurality of touch driving electrodes, wherein,
the touch sensing electrodes are disposed between color pixel units in adjacent rows or in adjacent column and have a function of shielding light; and
the touch driving electrodes are disposed to be insulated from and cross the touch sensing electrodes, and are applied with touch scanning signals at a touch stage and are applied with common electrode signals at a display stage.

2. The touch panel of claim 1, wherein the touch sensing electrodes are formed by an opaque conductive oxide material or opaque conductive metal material.

3. The touch panel of claim 1, wherein light shielding strips are further disposed on the first substrate and the light shielding strips are disposed between the color pixel units in adjacent rows or in adjacent column except positions being disposed with the touch sensing electrodes.

4. The touch panel of claim 3, wherein the light shielding strips are formed of a black resin insulation material.

5. The touch panel of claim 3, wherein floating electrodes are disposed between adjacent touch sensing electrodes on the first substrate.

6. The touch panel of claim 1, further comprising a second substrate disposed opposite to the first substrate, wherein a plurality of pixel display units arranged in a same way as the color pixel units are formed on the second substrate, a reflective region and a transmissive region are provided in each of the pixel display units, a metal reflective layer is disposed in the reflective region, and the reflective region surrounds the transmissive region.

7. The touch panel of claim 6, wherein the metal reflective layer covers a portion of a region between adjacent pixel display units in the column direction.

8. The touch panel of claim 7, wherein the touch sensing electrodes are disposed between the color pixel units in adjacent columns.

9. The touch panel of claim 5, wherein the touch driving electrodes and the touch sensing electrodes are disposed on different layers and are disposed in a row direction of the color pixel units.

10. A display device comprising the touch panel of claim 1.

11. The touch panel of claim 2, wherein light shielding strips are further disposed on the first substrate and the light shielding strips are disposed between the color pixel units in adjacent rows or in adjacent column except positions being disposed with the touch sensing electrodes.

12. The touch panel of claim 11, wherein the light shielding strips are formed of a black resin insulation material.

13. The touch panel of claim 11, wherein floating electrodes are disposed between adjacent touch sensing electrodes on the first substrate.

14. The touch panel of claim 13, wherein the touch driving electrodes and the touch sensing electrodes are disposed on different layers and are disposed in a row direction of the color pixel units.

15. The touch panel of claim 2, further comprising a second substrate disposed opposite to the first substrate, wherein a plurality of pixel display units arranged in a same way as the color pixel units are formed on the second substrate, a reflective region and a transmissive region are provided in each of the pixel display units, a metal reflective layer is disposed in the reflective region, and the reflective region surrounds the transmissive region.

16. The touch panel of claim 15, wherein the metal reflective layer covers a portion of a region between adjacent pixel display units in the column direction.

17. The touch panel of claim 16, wherein the touch sensing electrodes are disposed between the color pixel units in adjacent columns.

18. The touch panel of claim 17, wherein the touch driving electrodes and the touch sensing electrodes are disposed on different layers and are disposed in a row direction of the color pixel units.
